(19) United States
(12) Patent Application Publication
(10) Pub. No.: US 2006/0091685 A1
(43) Pub. Date: May 4, 2006

(54) Play/athletic training appliance

(76) Inventors: Sven-Ake Sjostam, Aneby (SE); John Granstrom, Aneby (SE)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/230,424

(22) Filed: Sep. 20, 2005

Related U.S. Application Data
(60) Provisional application No. 60/611,341, filed on Sep. 20, 2004.

(51) Int. Cl. B60P 3/00

(52) U.S. Cl. 296/2

(57) ABSTRACT

The present invention relates to a play/athletic training appliance, which is characterized in that it comprises at least one closed body with a central pivot shaft which is essentially horizontal or is inclined less than 45° to the horizontal plane, The closed body is arranged to pivot freely on the central pivot shaft. The closed body holds a ballast damping the pivoting motion.

### CROSS-REFERENCE TO RELATED APPLICATIONS

This application is related to U.S. Provisional Patent Application No. 60/611,341 filed Sep. 20, 2004 from which priority is claimed, and is hereby incorporated by reference.

### STATEMENT REGARDING FEDERALLY SPONSORED RESEARCH

Not Applicable.

### BACKGROUND OF THE INVENTION

The present invention relates a play/athletic training appliance. The appliance is in the first place intended for use in playgrounds and similar environments, but can also be used in other places.

### SUMMARY OF THE INVENTION

An appliance according to the present invention comprises a closed body which is freely mounted in bearings so as to pivot when a user tries to sit on it, stand on it or run on it. The main function of the invention is for the user to try to ride on it and, as an element of competition, try to reach a certain position by pivoting the closed body under himself.

The present invention provides a play/athletic training appliance, which is arranged to be adjusted to users of different ages and sizes:
is ergonomically correct
offers a possible element of competition;
can be used separately or be combined with several such appliances;
gives the user a chance of training his coordination;
has tactile position indications which can be felt by a visually handicapped user;
satisfies all safety requirements that are placed on this type of product;
can be made in one piece (shape based on a cone); and
is of educational interest in terms of geometric shapes and power conditions.

The play/athletic training appliance comprises at least one closed body with a central pivot shaft which is essentially horizontal or is inclined less than 45° to the horizontal plane. The closed body is arranged to pivot freely on the central pivot shaft. The closed body holds a ballast which affects the pivoting motion. The ballast can counteract and/or coact with the pivoting motion.

The foregoing and other features, and advantages of the invention as well as embodiments thereof will become more apparent from the reading of the following description in connection with the accompanying drawings.

### DESCRIPTION OF THE DRAWINGS

In the accompanying drawings which form part of the specification:

FIG. 1 is a side view of a closed body according to the invention,

FIG. 2 is a cross-section of the closed body in FIG. 1, freely mounted in bearings on a pivot shaft, the cross-section being taken along the pivot shaft,

FIG. 3a is cross-section, perpendicular to the pivot shaft, of the closed body in FIGS. 1 and 2,

FIG. 3b is a cross-section, perpendicular to the pivot shaft, of the closed body in FIGS. 1 and 2, and

FIG. 4 illustrates two closed bodies according to the invention which are arranged with a common pivot shaft.

Corresponding reference numerals indicate corresponding parts throughout the several figures of the drawings.

### DETAILED DESCRIPTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

The play/athletic training appliance comprises at least one closed body, which is designated 2 in the drawings. The closed body 2 is arranged with a pivot shaft 4, on which the closed body 2 pivots. The pivot shaft 4 will be described below. The closed body 2 is intended for a user in the first place to sit on, the closed body 2 to sit on, like on a horse, for instance in a straddling position. The closed body is also intended for a user to stand or run on.

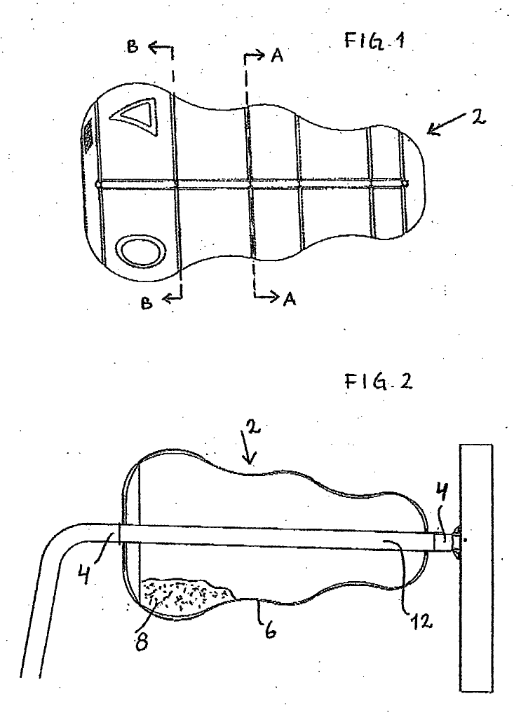

In a first embodiment, the main shape of the closed body 2 is conical in relation to the pivot shaft 4, see FIG. 2. In another embodiment, the main shape of the closed body 2 can be cylindrical (not shown) in relation to the pivot shaft 4, or otherwise symmetrical or unsymmetrical, for instance triangular.

The closed body 2 is further marked with at least one indication 6 indicating where the user is intended to sit or stand. The indication 6 is formed as a recess or a plurality of recesses in the closed body 2. Thus the closed body 2 has a wavelike surface which makes it possible for at least two users to sit on it at the same time, in a wave shape each. Clear indications 6 give a more ergonomic fit for the user to sit, which is adjusted to different ages and sizes.

The closed body 2 is also provided with tactile marks which are arranged round the closed body 2. These marks give the user a possible element of competition, in which the user should pivot the closed body 2 under himself and reach a certain mark. The surface structure of the closed body 2 is designed so that the indications 6 are perfectly smooth while the other surfaces have a friction surface. The surfaces are prepared so that a visually handicapped person can decide where the intended sitting surface is to be found.

In a first embodiment of the invention, see the Figures, the closed body 2 has five different extreme radii, see FIGS. 1 and 2. To make the closed body 2 pivot requires less physical efforts where the radius is greater. The differences between the varying power conditions between the radii affect the sitting, walking and running function.

The closed body 2 is advantageously made in one piece by rotation casting; in this way the closed body 2 will have no joints and the like, which may rip open or may scratch a user. The closed body 2 can also be made of two or more parts which can be joined, for instance using glue, or the like.

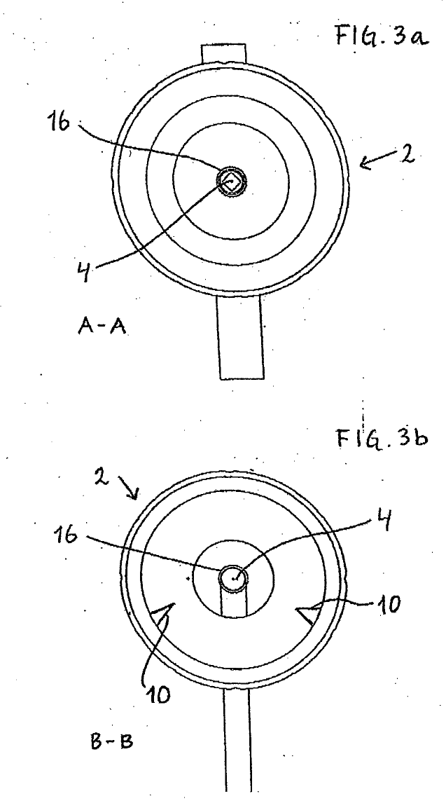

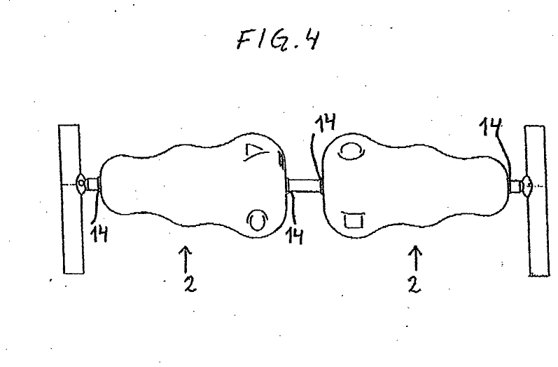

The closed body 2 holds a freely movable ballast 8, which affects the pivoting motion and which preferably is sand or gravel. The ballast 8 can also comprise steel balls, different types of liquids, oil, polymer mixtures and the like. The ballast 8 has a weight of about 10-40 kg, preferably about 15-25 kg. The closed body 2 can on the inside be provided with low partition walls 10 or the like, which affect the ballast, “the sand is to swish about”, see FIG. 3b. When the ballast 8 comprises sand or gravel, its angle of repose should not be affected by external circumstances; for instance the ballast should not stick if it is wet and damp outside.

When testing the ballast 8, it has been found that the counteracting effect of the ballast 8 arises when the person “riding on the closed body 2 tries to change his posture.

The closed body 2 is provided with a through tube 12. In both ends 14 of the through tube 12, bearings 16 are arranged, for instance slide bearings, in which bearings 16 the closed body 2 is mounted on the pivot shaft 4. The pivot shaft 4 may comprise\, for example, some kind of prior art stand, such as a bent steel tube. A strip is arranged between the bearing 16 and the pivot shaft 4 to have a damping and/or sealing effect, such as a stop strip, strip seal or the like. In one embodiment, the closed body 2 can be provided without the through tube 12. In that case, the bearings 16 are mounted directly on fastening elements (not shown) arranged on the closed body 2.

The central pivot shaft 4 is essentially horizontal. It may also be angled so as to be inclined, but less than 45° to the horizontal plane. The closed body 2 is arranged to pivot freely on the central pivot shaft 4. The ballast 8 held by the closed body 2 affects the pivoting motion by counteracting and, thus, damping it. The ballast 8 can also coact with the pivoting motion and, thus, reinforce it.

In another embodiment, two closed bodies 2 are arranged on a common pivot shaft 4 (see FIG. 4).

The present invention has now been described by means of a number of embodiments, and it should be understood that various modifications and supplements can be made within the scope of the invention as defined in the appended claims.

### REFERENCE NUMERALS

| | |
|---|---|
| Closed body | 2 |
| Pivot shaft | 4 |
| Indication | 6 |
| Ballast | 8 |
| Partition wall | 10 |
| Through tube | 12 |
| End | 14 |
| Bearing | 16 |

What is claimed is:

1. A play/athletic training appliance comprising:
at least one closed body with a central pivot shaft, which is essentially horizontal or is inclined less than 45° to the horizontal plane,
said closed body being arranged to pivot freely on said central pivot shaft,
said closed body continue a freely movable ballast, which affects the pivoting motion.

2. The play/athletic training appliance of claim 1, wherein the closed body is freely mounted about the in bearings at least at two ends of the body.

3. The play/athletic training appliance of claim 2, wherein the closed body is freely mounted about the shaft by bearings by at least one through hole in the closed body.

4. The play/athletic training appliance of claim 1, wherein the ballast has a weight of about 10-40 kg, preferably about 15-25 kg, which counteracts the pivoting motion.

5. The play/athletic training appliance of claim 1, wherein the ballast (9) is sand or gravel.

6. The play/athletic training appliance of claim 1, wherein the closed body is generally conical in relation to the pivot shaft.

7. The play/athletic training appliance of claim 1, wherein the closed body is generally cylindrical in relation to the pivot shaft.

8. The play/athletic training appliance of claim 5, wherein the closed body has a wavelike surface.

9. The play/athletic training appliance of claim 6, wherein the closed body has a wavelike surface.

10. The play/athletic training appliance of claim 1, wherein the closed body is marked with at least one indication to indicate the intended sitting surface or position.

11. The play/athletic training appliance of claim 10, wherein the indication is formed as a recess in the closed body.

12. The play/athletic training appliance of claim 1, wherein the closed body is rotationally cast.

13. The play/athletic training appliance of claim 1, comprising two closed bodies arranged on a common pivot shaft.
